(19) United States
(12) Patent Application Publication
(10) Pub. No.: US 2022/0363194 A1
(43) Pub. Date: Nov. 17, 2022

(54) VEHICULAR DISPLAY SYSTEM WITH A-PILLAR DISPLAY

(71) Applicant: Magna Electronics Inc., Auburn Hills, MI (US)

(72) Inventor: Joshua G. Windeler, Grand Blanc, MI (US)

(21) Appl. No.: 17/662,279

(22) Filed: May 6, 2022

Related U.S. Application Data
(60) Provisional application No. 63/201,732, filed on May 11, 2021.

(51) Int. Cl. B60R 1/23; G06V 20/59; H04N 7/18

(52) U.S. Cl. CPC B60R 1/23; G06V 20/597; H04N 7/183; B60R 2011/0022

(57) ABSTRACT

A vehicular vision system includes an A-pillar display device disposed at an interior A-pillar region of a vehicle, a blind spot camera, and a driver monitoring camera. The blind spot camera at least partially views an A-pillar blind spot region forward and sideward of the vehicle. An ECU receives image data captured by the blind spot camera. The A-pillar display device displays A-pillar blind spot video images derived from video image signals provided from the ECU. The ECU receives and processes image data captured by the driver monitoring camera to determine a gaze direction of the driver. Responsive to the determined gaze direction being toward the A-pillar blind spot region, the ECU provides video image signals derived from image data captured by the blind spot camera to the A-pillar display device. The A-pillar display device displays A-pillar blind spot video images derived from the received video image signals.

### CROSS REFERENCE TO RELATED APPLICATION

The present application claims the filing benefits of U.S. provisional application Ser. No. 63/201,732, filed May 11, 2021, which is hereby incorporated herein by reference in its entirety.

### FIELD OF THE INVENTION

The present invention relates generally to a vehicle vision system for a vehicle that provides the driver of the vehicle with views exterior of the vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A driving assistance system or vision system or imaging system for a vehicle utilizes one or more cameras (preferably one or more CMOS cameras) to capture image data representative of images exterior of the vehicle, and displays video images representative of the captured image data at a display device at an interior portion of the vehicle, such as an A-pillar display device at an A-pillar region of the interior of the vehicle. The vision system captures image data that is representative of at least a portion of a blind spot of a driver of the vehicle, such as an A-pillar blind spot, and displays video images (that are representative of at least a portion of the blind spot) at the display device at the interior portion of the vehicle responsive to a determined driver condition or a determined vehicle condition. The driver condition is a determination that the driver is viewing a region that includes at least a portion of the blind spot region and the vehicle condition may be determined responsive to a signal from a system of the vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle having a vehicle vision system;

FIG. 2 is a plan view of a vehicle with an A-pillar display device; and

FIG. 2A is a perspective view of the A-pillar display device interior the vehicle at section A of FIG. 2.

### DESCRIPTION OF THE PREFERRED EMBODIMENTS

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle and/or provide enhanced views exterior of the vehicle to the driver of the vehicle. The vision system includes an image processor or image processing system that is operable to receive image data from one or more cameras and provide an output to a display device for displaying images representative of the captured image data.

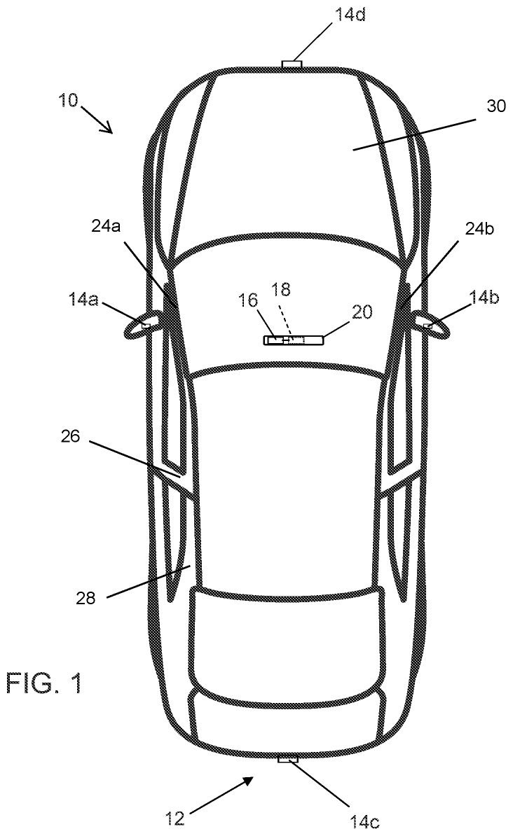

Referring now to the drawings and the illustrative embodiments depicted therein, a vehicle 10 includes a vision system 12 that includes at least one exterior viewing imaging sensor or camera, such as a sideward/forward viewing imaging sensor or camera 14a at the driver side of the vehicle (such as at an exterior rearview mirror position) and viewing at least sideward and forward of the vehicle (and the system may optionally include multiple exterior viewing imaging sensors or cameras, such as a sideward/forward viewing camera 14b at the passenger side of the vehicle, a rearward viewing camera 14c at the rear of the vehicle, and a forward viewing camera 14d such as at the front or windshield of the vehicle), and which captures images exterior of the vehicle, with the camera having a lens for focusing images at or onto an imaging array or imaging plane or imager of the camera (FIG. 1). The vision system may also include a sideward/rearward viewing camera at one or both sides of the vehicle (such as at the exterior rearview mirror position or at one or more door handles or pillars of the vehicle) which capture images rearward and sideward of the vehicle. The vision system 12 includes a control or electronic control unit (ECU) 16 having electronic circuitry and associated software, with the electronic circuitry including a data processor or image processor that is operable to process image data captured by the camera or cameras, whereby the ECU 16 may process captured image data to detect or determine presence of objects or the like and/or the ECU may process captured image data and generate video images derived from the captured image data so that the system may provide displayed video images at a display device for viewing by the driver of the vehicle. The data transfer or signal communication from the camera to the ECU may comprise any suitable data or communication link, such as a vehicle network bus or the like of the equipped vehicle.

The vehicle 10 is equipped with a “see-through” A-pillar display system, which utilizes a camera to capture what is behind an A-pillar 24 of the vehicle 10, aimed outside the vehicle 10 in line with the driver's sight. An A-pillar 24 of the vehicle 10 obstructs at least a portion of a driver's view when the driver views forward and sideward of the vehicle 10 when driving the vehicle 10 (i.e., when seated in a driver's seat of the vehicle) and these obstructed portions of the driver's view are known as the A-pillar blind spots. Video images derived from image data captured by a camera and representing a view of at least a portion of one or both of the A-pillar blind spots are displayed on an A-pillar via an A-pillar display device 22, which may comprise, for example, a curved display at an interior surface of the A-pillar 24 or a projected display that projects video images onto the interior surface of the A-pillar 24 from a remote location. The A-pillar display device 22 may utilize aspects described in U.S. Pat. No. 10,960,822, which is hereby incorporated herein by reference in its entirety.

The images displayed at the A-pillar display device 22, when viewed by a driver of the vehicle, reduce or eliminate the A-pillar blind spot. Additionally, displays can be disposed at the driver-side A-pillar 24a (and/or passenger-side A-pillar 24b) or at any of the vehicle pillars or other structure of the vehicle that obstruct portions of the driver's view when viewing exterior of the vehicle. For example, a B-pillar 26 of the vehicle between the front doors of the vehicle and the rear portion of the vehicle may obstruct the driver's view when the driver views rearward and sideward of the vehicle (such as when the driver is maneuvering the vehicle in a rearward direction or performing a lane change). Similarly, a C-pillar 28 or D-pillar at the rear of the vehicle may obstruct the driver's view when the driver views rearward and sideward of the vehicle. Although described sometimes herein as a driver-side A-pillar display device, it should be understood that similar components and methods may be utilized to provide display devices at any surface or interior portion of the vehicle to reduce or eliminate a blind spot caused by the corresponding structure of the vehicle and to allow the driver to effectively view through the structure at which the display device is disposed. In other words, the display device allows the driver to view exterior the vehicle and at the region of the environment exterior the vehicle that would otherwise be obstructed or blocked from view by the structure of the vehicle, such as to view objects, other vehicles, pedestrians, and the like in that region of the environment. For example, an A-pillar display device at the passenger-side A-pillar 24b may reduce or eliminate an A-pillar blind spot at the passenger side of vehicle 10.

Thus, the A-pillar display device 22 is beneficial for a driver of the vehicle 10 as it improves visibility around the vehicle 10 which can improve driver confidence and reduce chances of collisions between the equipped vehicle 10 and other vehicles and/or objects that may otherwise be obstructed from the view of the driver by the A-pillar 24 of the vehicle. However, an A-pillar display that is active at all times the vehicle is in operation can distract the driver and provide an unnecessary and significant power drain on the power systems of the vehicle. Thus, the system may reduce distracted driving that may be caused by displaying A-pillar video images at all times and may reduce power used by the system by selectively or episodically operating or activating the display device (i.e., displaying images at the display device). Episodic activation of the A-pillar display 24 can be tied to certain vehicle conditions (such as a determination that the vehicle is turning or a determination of vehicle speed or a determination of the current gear of the transmission of the vehicle or a determination of a current propulsion selection (e.g., forward or rearward) of the vehicle) and/or certain driver conditions (such as a determination of where a gaze of the driver indicates the driver is looking or a determined attention level of the driver). For example, the system 12 may only activate the A-pillar display system when the driver is looking at or toward the A-pillar and/or A-pillar blind spot (such as determined by a driver monitoring system of the vehicle). Thus, the present vehicle vision system 12 operates the A-pillar display device 22 responsive to a vehicle condition and/or a driver condition to maximize the efficiency of the vision system and reduce potential distractions caused by operation of the A-pillar display device 22.

As mentioned above, the vehicle may also be equipped with a driver monitoring system (DMS) which tracks the driver's eye and head position, calculating a driver's gaze or the vector at which they are looking. The DMS includes a driver monitoring camera 18 disposed at an interior portion of the vehicle and having a field of view that includes at least a head region of a driver of the vehicle. The DMS camera 18 may be utilized to monitor the driver of the vehicle (such as for safety systems of the vehicle), to provide video calling capabilities, or for any suitable function. By processing image data captured by the DMS camera 18 at the ECU 16, the vision system 12 may be capable of tracking the driver's eye and head movements to determine, for example, a gaze direction of the driver, whether the driver is looking at the road (and optionally where the driver is looking on the road), whether the driver is viewing one of the rearview mirrors of the vehicle, an attention level of the driver, and/or whether the driver is looking elsewhere in the interior of the vehicle or exterior the vehicle. Furthermore, by processing the image data captured by the DMS camera 18, the system 12 may determine whether the gaze direction of the driver is toward a blind spot region (and optionally where in the blind spot region the driver is attempting to view). Although shown as disposed at the interior rearview mirror 20 of the vehicle, the DMS camera 18 and ECU 16 of the vision system 12 may be disposed elsewhere in the vehicle, such as at a windshield-mounted electronics module or the like.

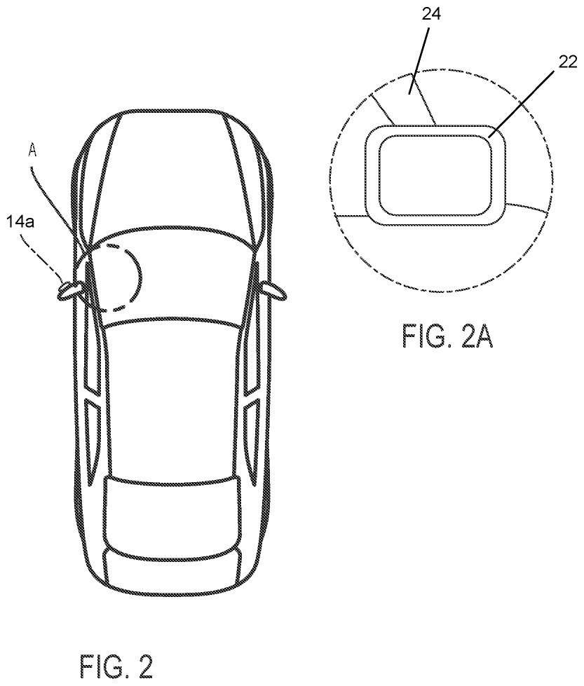

As shown in FIG. 2, one or more cameras of the system (such as the forward/sideward viewing camera 14a at the driver side of the vehicle) captures image data representative of a view that includes at least a portion of the A-pillar blind spot. As shown in FIG. 2A, an A-pillar display device 22 is mounted at a driver-side A-pillar 24 of the vehicle for displaying video images representative of the environment exterior the vehicle and behind the A-pillar 24 (i.e., including at least a portion of the A-pillar blind spot). The ECU 16 may receive image data from the camera 14a, process the image data, and provide video image signals to the A-pillar display device 22. Responsive to receiving the video image signals from the ECU 16, the A-pillar display device 22 is operable to display driver-side A-pillar blind spot video images representative of the provided video image signals, but the A-pillar display device 22 only displays the driver-side A-pillar blind spot video images responsive to a determined vehicle condition or a determined driver condition. That is, the A-pillar display device 22 displays video images representative of an area exterior the vehicle and including at least a portion of the A-pillar blind spot to reduce or eliminate the A-pillar blind spot and increase the visibility for the driver of the vehicle, but only when a condition is triggered so as to reduce distractions and power consumption caused by continuous operation of the display device.

A driver condition that triggers display at the A-pillar display device 22 of video images may be determined responsive to processing image data captured by the vehicle's DMS camera 18. For example, the vision system 12, via processing at the ECU 16 of image data captured by the DMS camera 18, may determine that the driver is looking toward an A-pillar 24 of the vehicle 10 (i.e., a determined gaze direction of the driver is towards the A-pillar), such as to view an area exterior the vehicle that includes at least a portion of the A-pillar blind spot. For example, the vehicle may be at an intersection and the driver may be looking toward the sides of the vehicle to check for oncoming traffic on the crossroad. Responsive to a determination that the driver is looking toward the A-pillar or toward an area that includes at least a portion of the A-pillar blind spot of the vehicle, the system 12 may activate the A-pillar display 22 so that the driver of the vehicle may view images at the A-pillar display 22 representative of at least a portion of the A-pillar blind spot. Thus, the driver is able to effectively view through or around the A-pillar to see objects or other vehicles or pedestrians that may otherwise be blocked from view by the A-pillar. Optionally, in systems with A-pillar display devices disposed at both A-pillar regions of the vehicle, the system may determine that the driver is looking in the direction of one A-pillar or the other and only display images at the A-pillar display device that the driver is viewing. Similarly, in systems with display devices disposed at the B-pillar, C-pillar, and/or D-pillar of the vehicle, the system may determine that the driver is looking in the direction of one or more of the pillars and display images at the display device in the field of view of the driver. For example, the driver may look behind them, over their shoulder, while performing a reversing maneuver and the system may activate display devices at the rearward pillars (e.g., B-pillar, C-pillar, D-pillar, etc.) to provide the driver with a more complete field of view rearward of the vehicle. Optionally, the system may determine that the driver is looking rearward when the driver's gaze is directed at the interior rearview mirror 20 and the system may activate display devices at the rearward pillars responsive to determining that the driver is viewing the interior rearview mirror 20.

A vehicle condition that triggers display at the A-pillar display device 22 of video images may be determined responsive to a signal from a system of the vehicle. For example, the system may determine that the vehicle is turning or about to turn (such as via operation of a turn signal of the vehicle or a steering input) and operate the A-pillar display device 22 responsive to such a determination. Optionally, in systems with A-pillar display devices 22 disposed at both A-pillar regions 24 of the vehicle, the system may determine that the vehicle is turning or about to turn in a certain direction (left or right) and only display images at the A-pillar display device corresponding to the turning direction.

Optionally, the vehicle condition that triggers display at the A-pillar display device 22 may be based on the vehicle's speed. For example, the vision system 12 may display images at the A-pillar display device 22 responsive to a determination that the vehicle 10 is travelling below a threshold speed, which may indicate that the vehicle 10 is travelling in an area in which it is more likely an obstacle or hazard could be present in the A-pillar blind spot (such as a parking lot or neighborhood). The system 12 may also be responsive to a selected gear of the vehicle 12. For example, the system may display images responsive to the vehicle's transmission being in a lower gear, such as only when the vehicle is in a first or second gear (which may correspond to a slower speed of the vehicle such as described above) or a reverse gear or reverse propulsion mode (which is entered via selection of a reverse gear of a transmission or selection of reverse propulsion of an electric vehicle). Furthermore, the system may activate the A-pillar display device 22 based on a location of the vehicle determined from a signal from a GPS system of the vehicle.

Optionally, the A-pillar display devices 22 may operate to display video images of the respective A-pillar blind spot regions exterior of the vehicle during a parking maneuver of the vehicle (such as responsive to determining that the vehicle is traveling slowly or is within a threshold distance to an object or curb or responsive to actuation by the driver of a user actuatable input), so that the driver can view the area sideward and forward of the vehicle cabin during a forward or reversing parking maneuver.

Furthermore, the vision system 12, via processing at the ECU 16 of image data captured by one or more cameras and/or sensors at the vehicle 10, may detect an object and/or hazard (such as another vehicle or a pedestrian or the like) in proximity to the vehicle 10. The vision system 12 may, responsive to a determination that an object is detected in proximity to the vehicle 10 (such as at or near the A-pillar blind spot of the vehicle), display video images at the A-pillar display device 22.

Additionally, the vision system 12 may episodically activate one or more A-pillar display devices 22 responsive to both a determined driver condition and a determined vehicle condition. For example, the system 12 may only activate an A-pillar display device 22 if, via processing at the ECU 16 of image data captured by the DMS camera 18, it is determined that the driver is viewing an area that includes at least a portion of an A-pillar blind spot and the system 12 receives a signal from a system of the vehicle 10 that indicates a determined vehicle condition (such as the vehicle travelling below a threshold speed or a steering input).

Optionally, the vision system may include a plurality of display devices disposed at different interior portions of the vehicle, such as at the respective driver and passenger side A-pillars 24 and respective driver and passenger side rearward pillars (such as the C-pillars or D-pillars), and the system may selectively activate one or more display devices based on a determined gaze direction or field of view of the driver, where the determined gaze direction or field of view of the driver may be determined by processing image data captured by the DMS camera 18 and estimating a line of sight or principal axis of the driver's gaze. For example, the A-pillar display devices may be selectively activated when the driver is viewing forward and toward one of the respective sides of the vehicle, while the rearward pillar display devices may be selectively activated when the driver views the rearview mirror or glances over their shoulder toward the rearward pillar.

Optionally a display device may be disposed in front of the driver and may be used to display video images representative of a field of view immediately in front of the vehicle, such as to reduce or eliminate the field of view of the driver that is blocked by the hood 30 of the vehicle when the driver views immediately forward of the vehicle. For example, the display device may be disposed at the gauge cluster or the dashboard of the vehicle. A camera may be disposed at the front fascia of the vehicle so as to have a field of view at or near ground level immediately in front of the vehicle and the image data captured by the camera may be processed to generate the video images provided to the driver at such a display device.

Optionally, the ECU 16 may process the image data captured by the DMS camera 18 to determine or estimate a line of sight or gaze direction or principal axis of the view direction of the driver of the vehicle and the system 12 may adjust the video images provided at the one or more display devices based on the determined gaze direction or principal axis of the view direction of the driver. For example, the system may determine the gaze direction or principal axis of the view direction of the driver to better match the displayed images at the display devices to what the driver would expect to see behind the obstructing structure of the vehicle. In other words, the images provided at the display device may be adjusted so as to align features of the video images with features viewed by the driver through the windshield or window of the vehicle. The driver's gaze direction or principal axis of the view direction or line of sight may be determined or estimated, for example, by determining a driver's head position relative to the one or more display devices and monitoring or tracking the driver's eye movements. This may improve the driver's understanding of what is viewed at the display device and increase the accuracy of the blind spot video images.

Thus, the vehicle vision system includes a display device at an interior portion of the vehicle, such as at one or both of the A-pillars of the vehicle (or at an interior portion of any suitable obstructing structure of the vehicle). The vision system includes one or more cameras disposed at the vehicle and viewing exterior of the vehicle, where a camera views at least a portion of a blind spot of the vehicle. The display device is operable to display video images derived from image data captured by the one or more cameras, the video images representative of the view exterior the vehicle and including at least a portion of the blind spot. The system displays video images at the display device responsive to a vehicle condition or a driver condition, such as responsive to when the driver is looking at or toward the obstructing structure of the vehicle. The driver condition may be determined responsive to processing of image data captured by a driver monitoring system of the vehicle. The vehicle condition may be determined responsive to a signal from a system of the vehicle.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 10,065,574; 10,017,114; 9,405,120 and/or 7,914,187, and/or U.S. Publication Nos. US-2022-0111857; US-2021-0323473; US-2021-0291739; US-2020-0202151; US-2020-0143560; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. patent application Ser. No. 17/650,255, filed Feb. 8, 2022 (Attorney Docket MAGO4 P4412), and/or Ser. No. 17/649,723, filed Feb. 2, 2022 (Attorney Docket MAGO4 P4410), and/or International Application No. PCT/US22/70882, filed Mar. 1, 2022 (Attorney Docket DON01 FP4421WO), which are hereby incorporated herein by reference in their entireties.

The ECU may receive image data captured by a plurality of cameras of the vehicle, such as by a plurality of surround view system (SVS) cameras and a plurality of camera monitoring system (CMS) cameras and one or more driver monitoring system (DMS) cameras. The ECU may comprise a central or single ECU that processes image data captured by the cameras for a plurality of driving assist functions and may provide display of different video images to a video display screen in the vehicle (such as at an interior rearview mirror assembly or at a central console or the like) for viewing by a driver of the vehicle. The system may utilize aspects of the systems described in U.S. Pat. Nos. 11,242,008 and/or 10,442,360, and/or 10,046,706, and/or U.S. Publication Nos. US-2021-0162926; US-2021-0155167; US-2019-0118717; US-2018-0134217 and/or US-2014-0285666, and/or International Application No. PCT/US22/70062, filed Jan. 6, 2022 (Attorney Docket DON09 FP4371W0), which are all hereby incorporated herein by reference in their entireties.

The vision system includes a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,708,410; 5,737,226; 5,802,727; 5,878,370; 6,087,953; 6,173,501; 6,222,460; 6,513,252 and/or 6,642,851, and/or U.S. Publication Nos. US-2014-0022390; US-2012-0162427; US-2006-0050018 and/or US-2006-0061008, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular vision system, the vehicular vision system comprising:
an A-pillar display device disposed at an interior A-pillar region of a vehicle equipped with the vehicular vision system and viewable by a driver of the vehicle;
a blind spot camera disposed at the vehicle, the blind spot camera at least partially viewing an A-pillar blind spot region forward and sideward of the vehicle, wherein the A-pillar blind spot region is at least in part caused by an A-pillar of the vehicle at least partially blocking a view of the driver when the driver views forward and sideward of the vehicle;
a driver monitoring camera with a field of view interior of the vehicle and including at least a head region of the driver of the vehicle;
an electronic control unit (ECU) comprising electronic circuitry and associated software, wherein the electronic circuitry comprises an image processor for processing image data received at the ECU;
wherein the blind spot camera captures image data, and wherein the ECU receives the image data captured by the blind spot camera;
wherein the A-pillar display device is operable to display A-pillar blind spot video images derived from video image signals provided from the ECU;
wherein the driver monitoring camera captures image data, and wherein the ECU receives and processes the image data captured by the driver monitoring camera to determine a gaze direction of the driver;
wherein, responsive at least in part to the determined gaze direction of the driver being toward at least a portion of the A-pillar blind spot region, the ECU provides video image signals derived from the image data captured by the blind spot camera to the A-pillar display device; and
wherein the A-pillar display device displays A-pillar blind spot video images derived from the video image signals received from the ECU.

2. The vehicular vision system of claim 1, wherein the A-pillar display device displays the A-pillar blind spot video images responsive to a vehicle condition.

3. The vehicular vision system of claim 2, wherein the ECU determines the vehicle condition responsive to a signal from a system of the vehicle.

4. The vehicular vision system of claim 3, wherein the vehicle condition comprises a determination that the vehicle is turning or about to turn.

5. The vehicular vision system of claim 3, wherein the vehicle condition comprises a determination that the vehicle is travelling at a speed below a threshold speed.

6. The vehicular vision system of claim 3, wherein the vehicle condition comprises a determination that the vehicle is in a reverse propulsion mode.

7. The vehicular vision system of claim 3, wherein the ECU determines the vehicle condition responsive to a signal from an object detection system of the vehicle.

8. The vehicular vision system of claim 7, wherein the vehicle condition comprises a determination that an object is at or near the A-pillar blind spot region.

9. The vehicular vision system of claim 1, wherein the A-pillar display device is disposed at the interior A-pillar region of the vehicle at a driver side of the vehicle and operable to display driver-side A-pillar blind spot video images.

10. The vehicular vision system of claim 9, further comprising an A-pillar display device disposed at an interior A-pillar region of the vehicle at a passenger side of the vehicle and operable to display passenger-side A-pillar blind spot video images.

11. The vehicular vision system of claim 10, wherein the A-pillar display device disposed at the interior A-pillar region of the vehicle at the driver side of the vehicle and the A-pillar display device disposed at the interior A-pillar region of the vehicle at the passenger side of the vehicle display the respective driver-side A-pillar blind spot video images and the passenger-side A-pillar blind spot video images responsive to a vehicle condition, and wherein the vehicle condition comprises a determination that the vehicle is turning or about to turn toward either the driver side of the vehicle or the passenger side of the vehicle, and wherein, responsive to the vehicle condition, the A-pillar display device disposed at the interior A-pillar region of the vehicle at the corresponding driver side or passenger side of the vehicle displays the corresponding driver-side or passenger-side A-pillar blind spot video images.

12. The vehicular vision system of claim 10, wherein the determined gaze direction of the driver comprises determination that the driver is viewing a region that includes at least a portion of the A-pillar blind spot region at either the driver side of the vehicle or the passenger side of the vehicle, and wherein, responsive to the determination, the A-pillar display device disposed at the interior A-pillar region of the vehicle at the corresponding driver side or passenger side of the vehicle displays the corresponding driver-side or passenger-side A-pillar blind spot video images.

13. The vehicular vision system of claim 1, wherein the determined gaze direction of the driver indicates a current viewing direction of the driver, and wherein the A-pillar blind spot video images are adjusted based on the current viewing direction of the driver.

14. A vehicular vision system, the vehicular vision system comprising:
a display device disposed at an interior portion of a vehicle equipped with the vehicular vision system and viewable by a driver of the vehicle;
a blind spot camera disposed at the vehicle, the blind spot camera at least partially viewing a blind spot region, wherein the blind spot region is at least in part caused by structure of the vehicle at least partially blocking a view of the driver when the driver views exterior of the vehicle;
a driver monitoring camera with a field of view interior of the vehicle and including at least a head region of the driver of the vehicle;
an electronic control unit (ECU) comprising electronic circuitry and associated software, wherein the electronic circuitry comprises an image processor for processing image data received at the ECU;
wherein the blind spot camera captures image data, and wherein the ECU receives the image data captured by the blind spot camera;
wherein the display device is operable to display blind spot video images derived from video image signals provided from the ECU;
wherein the driver monitoring camera captures image data, and wherein the ECU receives and processes the image data captured by the driver monitoring camera to determine a gaze direction of the driver;
wherein, responsive at least in part to the determined gaze direction of the driver being toward at least a portion of the blind spot region, the ECU provides video image signals derived from the image data captured by the blind spot camera to the display device;
wherein the display device displays blind spot video images derived from the video image signals received from the ECU; and
wherein the display device displays the blind spot video images responsive to a vehicle condition, and wherein the ECU determines the vehicle condition responsive to a signal from a system of the vehicle.

15. The vehicular vision system of claim 14, wherein the display device is disposed at an interior A-pillar region of the vehicle, wherein the blind spot region comprises an A-pillar blind spot region forward and sideward of the vehicle and at least in part caused by an A-pillar of the vehicle at least partially blocking a field of view of the driver when the driver views forward and sideward of the vehicle, and wherein the blind spot video images comprise A-pillar blind spot video images.

16. The vehicular vision system of claim 14, wherein the display device is disposed at an interior rear pillar region of the vehicle, wherein the blind spot region comprises a rear pillar blind spot region rearward and sideward of the vehicle and at least in part caused by a rear pillar of the vehicle at least partially blocking a field of view of the driver when the driver views rearward and sideward of the vehicle, and wherein the blind spot video images comprise rear pillar blind spot video images.

17. The vehicular vision system of claim 16, wherein the interior rear pillar region of the vehicle includes at least one selected from the group of (i) an interior B-pillar region of the vehicle, (ii) an interior C-pillar region of the vehicle, and (iii) an interior D-pillar region of the vehicle.

18. The vehicular vision system of claim 16, wherein the display device displays the rear pillar blind spot video images responsive to the determined gaze direction of the driver being indicative of the driver viewing a reflective element of an interior rearview mirror assembly of the vehicle.

19. The vehicular vision system of claim 14, wherein the display device is disposed at a dashboard region of the vehicle, wherein the blind spot region comprises a hood blind spot region immediately forward of the vehicle and at least in part caused by a hood of the vehicle at least partially blocking a field of view of the driver when the driver views immediately forward of the vehicle, and wherein the blind spot video images comprise hood blind spot video images.

20. The vehicular vision system of claim 14, wherein the determined gaze direction of the driver indicates a current viewing direction of the driver, and wherein the blind spot video images are adjusted based on the current viewing direction of the driver.

21. The vehicular vision system of claim 14, wherein the vehicle condition comprises a determination that the vehicle is turning or about to turn.

22. The vehicular vision system of claim 14, wherein the vehicle condition comprises a determination that the vehicle is travelling at a speed below a threshold speed.

23. The vehicular vision system of claim 14, wherein the vehicle condition comprises a determination that the vehicle is in a reverse propulsion mode.

24. The vehicular vision system of claim 14, wherein the ECU determines the vehicle condition responsive to a signal from an object detection system of the vehicle.

25. The vehicular vision system of claim 24, wherein the vehicle condition comprises a determination that an object is at or near the blind spot region.

26. A vehicular vision system, the vehicular vision system comprising:
a driver-side A-pillar display device disposed at an interior driver-side A-pillar region of a vehicle equipped with the vehicular vision system at a driver side of the vehicle and viewable by a driver of the vehicle;
a passenger-side A-pillar display device disposed at an interior passenger-side A-pillar region of the vehicle at a passenger side of the vehicle and viewable by the driver of the vehicle;
a driver-side blind spot camera disposed at the vehicle, the driver-side blind spot camera at least partially viewing a driver-side A-pillar blind spot region forward and sideward of the driver side of the vehicle, wherein the driver-side A-pillar blind spot region is at least in part caused by a driver-side A-pillar of the vehicle at least partially blocking a forward and sideward view of the driver at the driver side of the vehicle;
a passenger-side blind spot camera disposed at the vehicle, the passenger-side blind spot camera at least partially viewing a passenger-side A-pillar blind spot region forward and sideward of the passenger side of the vehicle, wherein the passenger-side A-pillar blind spot region is at least in part caused by a passenger-side A-pillar of the vehicle at least partially blocking a forward and sideward view of the driver at the passenger side of the vehicle;
a driver monitoring camera with a field of view interior of the vehicle and including at least a head region of the driver of the vehicle;
an electronic control unit (ECU) comprising electronic circuitry and associated software, wherein the electronic circuitry comprises an image processor for processing image data received at the ECU;
wherein the driver-side blind spot camera and the passenger-side blind spot camera capture image data, and wherein the ECU receives the image data captured by the driver-side blind spot camera and the passenger-side blind spot camera;
wherein the driver-side A-pillar display device is operable to display driver-side A-pillar blind spot video images derived from video image signals provided from the ECU from the driver-side blind spot camera;
wherein the passenger-side A-pillar display device is operable to display passenger-side A-pillar blind spot video images derived from video image signals provided from the ECU from the passenger-side blind spot camera;
wherein the driver monitoring camera captures image data, and wherein the ECU receives and processes the image data captured by the driver monitoring camera to determine a gaze direction of the driver;
wherein, responsive at least in part to the determined gaze direction of the driver being toward at least a portion of the driver-side A-pillar blind spot region, the ECU provides video image signals derived from the image data captured by the driver-side blind spot camera to the driver-side A-pillar display device;
wherein the driver-side A-pillar display device displays driver-side A-pillar blind spot video images derived from the video image signals received from the ECU;
wherein, responsive at least in part to the determined gaze direction of the driver being toward at least a portion of the passenger-side A-pillar blind spot region, the ECU provides video image signals derived from the image data captured by the passenger-side blind spot camera to the passenger-side A-pillar display device;
wherein the passenger-side A-pillar display device displays passenger-side A-pillar blind spot video images derived from the video image signals received from the ECU; and
wherein the driver-side A-pillar display device and the passenger-side A-pillar display device display the respective driver-side A-pillar blind spot video images or passenger-side A-pillar blind spot video images responsive to a vehicle condition.

27. The vehicular vision system of claim 26, wherein the ECU determines the vehicle condition responsive to a signal from a system of the vehicle.

28. The vehicular vision system of claim 27, wherein the vehicle condition comprises a determination that the vehicle is travelling at a speed below a threshold speed.

29. The vehicular vision system of claim 27, wherein the vehicle condition comprises a determination that the vehicle is in a reverse propulsion mode.

30. The vehicular vision system of claim 27, wherein the ECU determines the vehicle condition responsive to a signal from an object detection system of the vehicle.

31. The vehicular vision system of claim 30, wherein the vehicle condition comprises a determination that an object is at or near the driver-side A-pillar blind spot region or the passenger-side A-pillar blind spot region.

32. The vehicular vision system of claim 26, wherein the vehicle condition comprises a determination that the vehicle is turning or about to turn toward either the driver side of the vehicle or the passenger side of the vehicle, and wherein, responsive to the vehicle condition, the corresponding driver-side A-pillar display device or the passenger-side A-pillar display device displays the corresponding driver-side or passenger-side A-pillar blind spot video images.
